(19) United States
(12) Patent Application Publication
(10) Pub. No.: US 2018/0211271 A1
(43) Pub. Date: Jul. 26, 2018

(54) APPARATUS, METHOD AND COMPUTER PROGRAM PRODUCT FOR BUDGET ALLOCATION IN DATA COLLECTION

(71) Applicant: Nokia Technologies Oy, Espoo (FI)

(72) Inventors: Dongsheng WANG, Songyuan (CN); Wendong WANG, Beijing (CN)

(73) Assignee: Nokia Technologies Oy, Espoo (FI)

(21) Appl. No.: 15/745,414

(22) PCT Filed: Jul. 29, 2015
(86) PCT No.: PCT/CN2015/085406

§ 371 Date: Jan. 16, 2018

(51) Int. Cl. G06Q 30/02

(52) U.S. Cl. CPC G06Q 30/0219; G06Q 30/0236

(57) ABSTRACT

Method, apparatus, computer program product and computer readable medium are disclosed for budget allocation in a data collection task. The method comprises; dividing the data collection task into a plurality of rounds (502); and determining a Csub-budget for a round based at least partly on information about one or more previous rounds and an available average sub-budget for remainder rounds (504).

### FIELD OF THE INVENTION

Embodiments of the disclosure generally relate to data processing, and more particularly, to data collection technologies.

### BACKGROUND

The fast development of networks and electronic devices has dramatically changed the way of data collection. Nowadays, most data collection tasks may relay on networks and electronic devices and in some cases require participation of users. For example, participatory sensing is a new paradigm of sensing data collection that may utilize ubiquitous sensor-embedded smart devices to collect various kinds of data, such as surrounding environment data around the users, and transmit them to a platform center through a public communication network, such as a cellular network or internet. Considering the widely distributed smart phones, and their mobility and pervasive characteristics, the resulting data collected by the participatory sensing turn out to be more representative and accurate than those gathered by traditional fixed monitor stations.

In general, the successful implementation of a data collection task, such as the participatory sensing, highly relies on involvement of adequate participants or users. However, individuals do not have a direct benefit from uploading data in some cases. Gathering data this way can be costly for users as it takes time, effort or even money of the users. Thus, an appropriate incentive mechanism (or budget allocation) to encourage individuals' participation is desirable.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to one aspect of the disclosure, it is provided a method for budget allocation in a data collection task. Said method may comprise: dividing the data collection task into a plurality of rounds; and determining a sub-budget for a round based at least partly on information about one or more previous rounds and an available average sub-budget for remainder rounds.

According to an embodiment, said method may further comprise setting a sub-budget for a first round as an initial value.

According to an embodiment, wherein the sub-budget comprises: a fixed part which is substantially the same amount for every successful participant; and a floating part which is determined according to a successful participant's contribution.

According to an embodiment, wherein the information about one or more previous rounds comprises sub-budget for the nearest previous round, data collection performance in the one or more previous rounds, and/or current market state.

According to an embodiment, wherein the data collection performance in a round is determined based at least partly on time used in the round, actual amount of data collected in the round and expected amount of data to be collected in the round.

According to an embodiment, wherein the budget allocation has a price deciding state and a price stabilizing state based on a price adjustment parameter.

According to an embodiment, wherein the price adjustment parameter is determined based at least partly on the data collection performance in the one or more previous rounds and the current market state.

According to various embodiments, said method may further comprise sending description about the data collection task and incentive information to a potential participant, wherein the incentive information contains at least information about the fixed part and floating part of the budget.

According to various embodiments, said method may further comprise stopping the data collection task when it is determined that the collected data satisfy a predefined criterion.

According to another aspect of the present disclosure, it is provided an apparatus comprising means configured to carry out the above-described method.

According to another aspect of the present disclosure, it is provided a computer program product embodied on a distribution medium readable by a computer and comprising program instructions which, when loaded into a computer, execute the above-described method.

According to still another aspect of the present disclosure, it is provided a non-transitory computer readable medium having encoded thereon statements and instructions to cause a processor to execute the above-described method.

According to still another aspect of the present disclosure, it is provided an apparatus for budget allocation in a data collection task. Said apparatus comprises: a dividing element configured to divide the data collection task into a plurality of rounds; and a determining element configured to determine a sub-budget for a round based at least partly on information about one or more previous rounds and an available average sub-budget for remainder rounds.

These and other objects, features and advantages of the disclosure will become apparent from the following detailed description of illustrative embodiments thereof, which is to be read in connection with the accompanying drawings.

### BRIEF DESCRIPTION OF THE DRAWINGS

FIG. 1 shows a schematic system, in which some embodiments of the present disclosure can be implemented;

FIG. 2 is a simplified block diagram illustrating an apparatus according to an embodiment of the present disclosure;

FIG. 3 is a simplified block diagram illustrating an apparatus according to another embodiment of the present disclosure;

FIG. 4 is a simplified block diagram illustrating an apparatus according to still another embodiment of the present disclosure;

FIG. 5 is a flow chart depicting a process for allocating budget in a data collection task according to an embodiment of the present disclosure;

FIG. 6 is a flow chart depicting a process for allocating budget in a data collection task according to another embodiment of the present disclosure; and

FIG. 7 is a flow chart depicting a process for allocating budget in a data collection task according to still another embodiment of the present disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

While the following embodiments are primarily discussed in the context of a participatory sensing task, it will be recognized by those of ordinary skill that the disclosure is not so limited. In fact, the various aspects of this disclosure are useful in any data collection task that can benefit from the budget allocation as is described herein.

As mentioned above, the successful implementation of a participatory sensing application or task may rely on involvement of adequate participants. Since individuals may not have a direct benefit from uploading data in some cases, the inclusion of incentive mechanism to encourage their participation may be essential. An objective of the incentive mechanism may be to motivate an adequate number of participants to submit sensing data, encourage them to upload quality data and cultivate good participatory habit. Meanwhile, the incentive mechanism may aim to minimize the platform costs and achieve a double-win with the participants.

The existing incentive mechanisms in data collection can be divided into two categories. One is referred to as a non-auction-based price decision method. An example of non-auction-based price decision method may promise an individual a fixed amount of money for a data collection task. One drawback of this method is that the incentive payment may be unfair for some participants because the quality of data provided by a participant may be different from another. Another example of non-auction-based price decision method is to provide a participant a fixed amount of money for each piece of sensing data. One drawback of this method is that it may result in participant fatigue since the incentive relates only to the uploaded amount of data. As still another example of non-auction-based price decision method, the incentive may include a fixed part and a float part that come from two entities respectively. For instance, the fixed part is provided by a service provider and is fixed all the time, and the float part is provided by a consumer who has purchased the data collected by a participant. One drawback of this method is that most participants may only obtain the fixed part, and cannot obtain the float part even if the data provided by them are same as the data purchased by the consumer.

The other category is known as an auction-based price decision method. This method introduces reversed auction into the data collection. In the reversed auction, N users of the lowest bids for their sensing data may be selected. A problem of this method is that it introduces users' gaming cost. Therefore, it is desirable to provide an improved technical solution for the budget allocation in the data collection task.

To avoid or mitigate at least some of the above problems, an embodiment is disclosed to provide a new budget allocation method. In this method, a data collection task is divided into a plurality of rounds. When the task is performed, a sub-budget is allocated for the current round, which may be adjusted based at least partly on information about one or more previous rounds and an available average sub-budget for remainder rounds. Moreover, a participant can obtain a fixed reward and an extra bonus related to his contribution to the data collection task in that round.

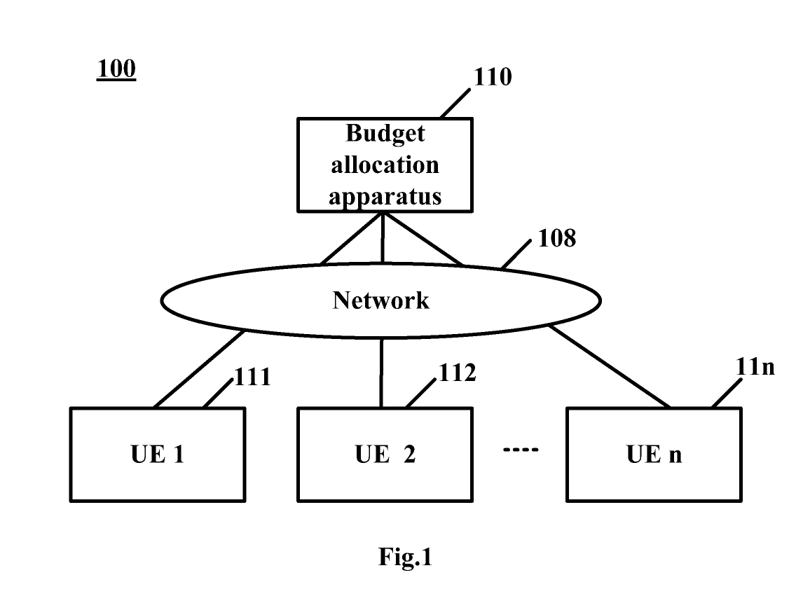

FIG. 1 depicts a schematic system, in which some embodiments of the present disclosure can be implemented. As shown in FIG. 1, the system 100 may comprise one or more user equipments (UEs) 111-11n each operably connected to a budget allocation apparatus 110 through one or more networks 108. The terms “user equipment”, “user device” and “mobile terminal” are interchangeably used. The user devices 111-11n can be any kind of user equipments or computing devices including, but not limited to, smart phones, tablets, laptops, servers, thin clients, set-top boxes and PCs, running with any kind of operating system including, but not limited to, Windows, Linux, UNIX, Android, iOS and their variants. For example, the user devices 111-11n can be Windows phones, having an app installed in it, with which the users can access services provided by the network 108.

Additionally, the user devices 111-11n may also participate a data collection task, such as a participatory sensing task. Where UEs 111-11n are mobile terminals such as smart phones, the mobile terminals can be equipped with any kinds of sensors, such as environmental sensors (temperature sensors, humidity sensors, air pressure sensors, etc.) and health sensors, to collect various kinds of data around and/or concerning the users. Although not shown in FIG. 1, there can be one or more data collection servers operably connected to the UEs 111-11n and configured to collect the sensing data from them.

The system 100 may also comprise a budget allocation apparatus 110 which is configured to perform functions related to the data collection task. In an embodiment, the budget allocation apparatus 110 can implement a budget allocation function. Alternatively the budget allocation apparatus 110 can also perform additional functions, such as data collection or data management functions. In some embodiments where there are multiple data collection tasks going on, the budget allocation apparatus 110 can also be used for those tasks. The budget allocation apparatus 110 can be implemented in form of hardware, software or their combination, including but not limited to, cloud computer, distributed computing system, virtual computer, smart phones, tablets, laptops, servers, thin clients, set-top boxes and PCs. The budget allocation apparatus 110 may run with any kind of operating system including, but not limited to, Windows, Linux, UNIX, Android, iOS and their variants.

The network 108 may comprise any kind of network or multiple networks operably connected. The terms “network” and “system” are often used interchangeably. Examples of the network 108 may include any wired or wireless network or their combination, including, but not limited to, a wireless cellular telephone network (such as the global system for mobile communications (GSM) network, 3rd generation (3G) network, 3.5th generation (3.5G) network, 4th generation (4G) network, universal mobile telecommunications system (UMTS), code division multiple access (CDMA) network etc), a wireless local area network (WLAN) such as defined by any of the Institute of Electrical and Electronic Engineers (IEEE) 802.x standards, an Ethernet local area network, a token ring local area network, a wide area network, and the Internet.

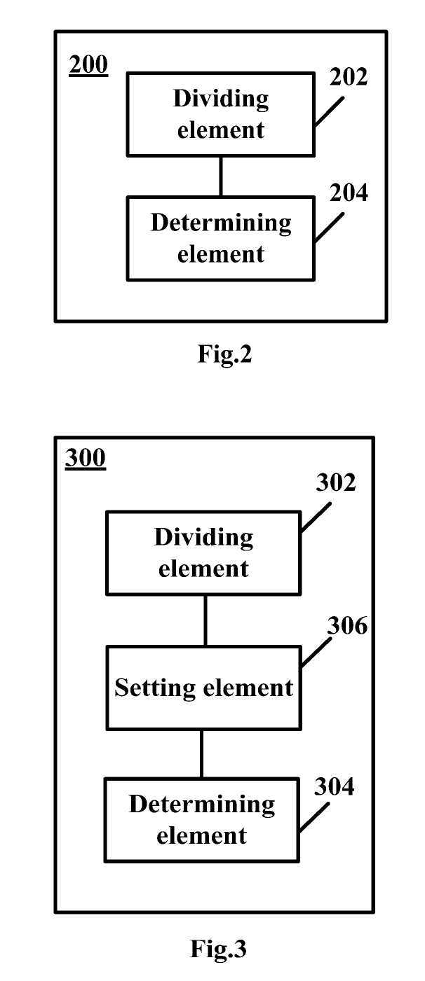

FIG. 2 shows a simplified block diagram of a budget allocation apparatus according to an embodiment of the present disclosure. As shown in FIG. 2, the budget allocation apparatus 200 may include a dividing element 202 configured to divide the data collection task into a plurality of rounds.

For example, the data collection task may be a participatory sensing task for collecting temperature data around users to make a temperature map. The participatory sensing task may comprise a budget B given by the task initiator. The budget can be money, game point, cash coupon, score or the like. For example, the budget B can be 10 dollar.

In the embodiment, the dividing element 202 may divide the data collection task into R rounds based on, for example, empirical or statistic data. Alternatively, the number of rounds can also be configured by the task initiator or manager. For example, some similar data collection tasks regarding temperature data has been performed one week ago, and the average round of these tasks is Rp, then the dividing element 202 can set the round of this data collection task as R=Rp. In other embodiments, the dividing element 202 can use any other suitable method to divide the data collection task into a plurality of rounds.

The budget allocation apparatus 200 may further comprise a determining element 204 configured to determine a sub-budget for a round based at least partly on information about one or more previous rounds and an available average sub-budget for remainder rounds. In general, the sub-budget of a round i which is denoted as B, may be smaller than or equal to an available average sub-budget for remainder rounds. For example, if a remainder budget is denoted as B′, and a remainder round number is denoted as R′, then

$${B}_{i} \leq \frac{{B}^{′}}{{R}^{′}} .$$

According to the embodiment, the information about one or more previous rounds comprises sub-budget for the nearest previous round, data collection performance in the one or more previous rounds, and/or current market state. The data collection performance in a round is determined based at least partly on time used in the round, actual amount of data collected in the round and expected amount of data to be collected in the round. In this embodiment, the determining element 204 can determine the data collection performance in a round i as follows:

$${α}_{i} = \frac{{t}_{i}}{{t}_{α i}} \times \frac{{n}_{α i}}{n} \qquad ( 1 )$$

Here, αᵢ denotes the data collection performance in the round i. t_{α}_{ᵢ} is the time used in the round i. n_{α}_{ᵢ} is the actual amount of data collected in the round i. tᵢ is the expected time or deadline used in the round i. n is the expected amount of data to be collected in the round i. It is noted that parameters tᵢ and n can be the same for every round or differently defined for respective rounds based on for example the data collection performance in one or more previous rounds.

In this embodiment, the parameters tᵢ and n are set to be the same for every round. In general, if tᵢ≥t_{αi}, it means that the round i may last for at most tᵢ. It can be observed that αᵢ can be greater than 1, equal to 1, or smaller than 1. For example, if the round i uses time tᵢ (i.e., tᵢ=t_{αi}) and obtains n pieces of data (i.e., n=n_{αi}), then αᵢ=1. If the round i uses time t_{αi}<tᵢ, and obtains n_{αi}=n pieces of data, then αᵢ>1. If the round i uses time tᵢ (i.e., tᵢ=t_{αi}) and obtains n_{αi}<n pieces of data, then αᵢ<1. It is noted that the data collection performance may also be determined by using any other suitable method, and the present embodiment has no limitation on it.

According to the embodiment, the budget allocation has a price deciding state and a price stabilizing state based on a price adjustment parameter. In the price deciding state β_{dy}, the determining element 204 may adjust the sub-budget for a round significantly in order to find the proper price rapidly. In the price stabilizing state β_{sd}, the determining element 204 may tune the sub-budget for the round slightly and avoid volatile markets caused by accident. By default, the budget allocation may be in the price deciding state, when it is initialized. The determining element 204 may maintain two state buckets, one for the price deciding state, β_{dy}, with a default value 1.0 and the other for the price stabilizing state, β_{sd}, with a default value 0.

The price adjustment parameter can be determined based at least partly on the data collection performance in the one or more previous rounds and the current market state. For example, if the determining element 204 gets the data collection performance αᵢ in previous rounds, it can compute the price adjust parameter Dᵢ₊₁ for a next round i+1 based at least partly on the data collection performance in the one or more previous rounds and the current market state as follows:

$${D}_{i + 1} = D ( A , β ) = \{ \begin{matrix}1 / {α}_{i} , & if β = {β}_{d y} \\ \frac{{\sum }_{j = i - M + 1}^{i} 1 / {α}_{j}}{M} , & if β = {β}_{sd}\end{matrix} \qquad ( 2 )$$

wherein A={αₖ, k ∈ [1, 2, . . . , i]} is the set of all the previous data collection performances, β is the current market state, β_{sd} denotes the parameter of the price stabilizing state, and β_{dy} denotes the parameter of the price deciding state. According to formula 2, if the budget allocation is in the price deciding state, Dᵢ₊₁ is only affected by the nearest round's information, i.e., αᵢ. In this way, Dᵢ₊₁ is sensitive to relations between demand and supply and the corresponding change in sub-budget allocation may be big. This is appropriate for the initial phase of the budget allocation and can make the price converging rapidly. If the budget allocation is in the price stabilizing state, Dᵢ₊₁ is affected by the nearest M rounds' information. In this way, it can avoid volatile markets and suitable for the situation where the market has been stabilized. It is noted that the price adjust parameter may also be determined by using any other suitable method that uses the data collection performance in one or more previous rounds and the current market state.

In the embodiment, the determining element 204 may determine the value of the price deciding state and the value of the price stabilizing state based at least partly on a comparison of an absolute difference of price adjust parameters of two adjacent rounds with a price adjust threshold as follows:

$$\begin{matrix}{β}_{dy} = \{ \begin{matrix}max \{ {β}_{dy} + ɛ , 1 \} & if \vert δ ( {D}_{i} ) \vert > {D}_{th} \\ min \{ {β}_{dy} - ɛ , 0 \} & else\end{matrix} & ( 3 ) \\ {β}_{sd} = \{ \begin{matrix}min \{ {β}_{sd} - ɛ , 0 \} & if \vert δ ( {D}_{i} ) \vert > {D}_{th} \\ max \{ {β}_{sd} + ɛ , 1 \} & else\end{matrix} & ( 4 )\end{matrix}$$

wherein |δ(Dᵢ)|=|−Dᵢ−Dᵢ₋₁|, ε denotes arbitrarily small positive quantity and Dₜₕ denotes a threshold.

The current market state can be determined by β=max{β_{dy}, β_{sd}}. Thus, in iteration (i.e., from one round to the next round), according to formula 3 and 4, if |δ(Dᵢ)| is not above the threshold Dₜₕ, the current market state will be in the price stabilizing state, otherwise the current market state will be in the price deciding state. The threshold Dₜₕ can be configured by the operator or determined from historical or statistics data.

Then, the determining element 204 can determine a sub-budget for a round based at least partly on information about one or more previous rounds and an available average sub-budget for remainder rounds. Specifically, according to the price adjust parameters Dᵢ₊₁ for next round i+1, Dᵢ₊₁>1 may indicate increasing the sub-budget of the next round i+1. Dᵢ₊₁<1 may indicate decreasing the sub-budget of the next round i+1. Dᵢ₊₁=1 may indicate stabilizing the sub-budget of the next round i+1. Moreover, in order to avoid deficit, the determining element 204 may compare the resulting next round's sub-budget with the available average sub-budget

$$\frac{{B}^{′}}{{R}^{′}}$$

to guarantee the sub-budget of the next round i+1 is not over allocated than the available average sub-budget

$$\frac{{B}^{′}}{{R}^{′}} ,$$

given that the reminder available budget is B′ and the reminder round number is R′. In this embodiment, the next round's sub-budget Bᵢ₊₁ can be determined as follows:

$${B}_{i + 1} = min \{ {B}_{i} \times {D}_{i + 1} , \frac{{B}^{′}}{{R}^{′}} \} \qquad ( 5 )$$

wherein Bᵢ is the nearest round's sub-budget. It is noted that the sub-budget may also be determined by using any other suitable method that is based at least partly on information about one or more previous rounds and an available average sub-budget for remainder rounds.

FIG. 3 is a simplified block diagram illustrating a budget allocation apparatus 300 according to another embodiment of the present disclosure. With reference to FIG. 3, the budget allocation apparatus 300 may include a dividing element 302 and a determining element 304 which are similar to the dividing element 202 and the determining element 204 shown in FIG. 2. For brevity, the description of elements 302, 304 is omitted herein.

As shown in FIG. 3, the budget allocation apparatus 300 may further comprise a setting element 304 which is configured to set a sub-budget for a first round as an initial value. As mentioned above, this sub-budget may also be smaller than or equal to an available average sub-budget for remainder rounds. In an embodiment, the sub-budget for the first round B₁ can be set to be at a low level, such as

$$\frac{B}{8 R} , \frac{B}{4 R} , \frac{B}{2 R} ,$$

or other suitable values, wherein

$$\frac{B}{R}$$

denotes the available average sub-budget for remainder rounds.

In another embodiment, after determining the sub-budget for a round, the sub-budget can be divided into two parts: a fixed part which is substantially the same amount for every successful participant; and a floating part which is determined according to a successful participant's contribution. The sum of the total fixed part and the total floating part can be smaller than or equal to the sub-budget for the round. The successful participants as used herein may refer to the participants who have submitted qualified data.

As an example, before performing a round i, the determining element 204, 304 can determine the fixed part for a successful participant s involved in the round i based at least partly on the sub-budget Bᵢ of the round i as follows:

$${f}_{s}^{i} = \frac{a \times {B}_{i}}{n} \qquad ( 6 )$$

wherein a is a constant smaller than 1 to adjust the ratio of the fixed part and the floating part, and n is expected amount of data to be collected in the round i. The constant a can be set as different values for different data collection tasks. In this embodiment, the fixed part is the same amount for every successful participant. Alternatively, the fixed part can also be different for every successful participant. For example, the fixed part for a successful participant can be proportional to a rating of his submitted data. It is noted that the fixed part for a successful participant may also be determined by using any other suitable method.

After a round i, the floating part for a successful participant s may be determined according to the successful participant's contribution as follows:

bₛⁱ=bᵢ×ρₛⁱ (7)

### Here,

$${b}_{i} = ( 1 - a ) \times {B}_{i} \times \frac{{n}_{i}}{n}$$

denotes the total floating part in the round i. a is the same constant as in formula 6. n is expected amount of data to be collected in the round i. nᵢ is actual amount of data collected in the round i.

$${ρ}_{s}^{i} = \frac{{U}_{0} ( {d}_{s}^{i} )}{{\sum }_{{s}^{′} ∈ S} {U}_{0} ( {d}_{{s}^{′}}^{i} )}$$

denotes the successful participant s's contribution proportion among all successful participants. The floating part is proportional to a participant's contribution. dₛⁱ is the user s's uploaded data and S is the set of successful participants. U₀( ) denotes system utility function which can be expressed with parameters of timeliness, sparsity, reputation, distribution, coverage and/or integrality etc. As an example, with the timeliness, an example U₀( ) may be defined as follows:

$${U}_{0} ( {d}_{s}^{i} ) = \{ \begin{matrix}1 & if {t}_{s} < {T}_{th} \\ 0.4 & else\end{matrix} \qquad ( 8 )$$

wherein, dₛⁱ is the user s's uploaded data, tₛ is a time point of the uploaded data of the user s, and Tₜₕ is a time threshold. For example, if the time threshold Tₜₕ is set to be 9:00 am, and a user has uploaded qualified data before 9:00 am, then the utility value of this data will be 1. Otherwise, it will be 0.4. It is noted that the system utility function can be implemented by using any other suitable parameters, and the present disclosure has no limit on it.

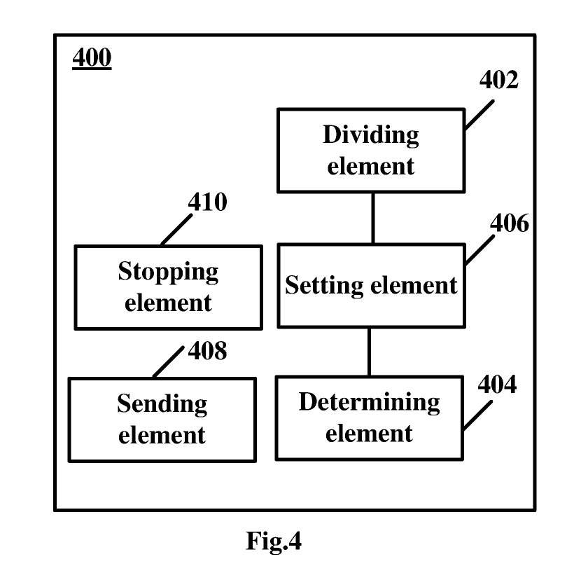

FIG. 4 is a simplified block diagram illustrating a budget allocation apparatus 400 according to still another embodiment of the present disclosure. With reference to FIG. 4, the budget allocation apparatus may include a dividing element 402, a determining element 404 and a setting element 406 which are similar to the dividing element 302, the determining element 304 and the setting element 306 shown in FIG. 3. For brevity, the description of elements 402, 404, 406 is omitted herein.

As shown in FIG. 4, the budget allocation apparatus 400 may further comprise a sending element 408. According to this embodiment, the sending element 408 may be configured to send description about the data collection task and incentive information to a potential participant, wherein the incentive information contains at least information about the fixed part and floating part of the budget. For example, the description may contain information about collecting real-time traffic condition in a specific road. The incentive information may notify the potential participants of the information about the fixed part (for example, 0.2 dollar for a piece of qualified data), and the floating part which may relate to contribution by a participant. The sending element 408 can use broadcast, multicast, unicast or other suitable transmission technologies in sending out the information.

In the embodiment, the sending element 408 may send a fixed part incentive to a successful participant immediately after receiving a piece of qualified data from the successful participant. This is because the fixed part incentive for a successful participant can be determined before starting a round in some cases. In this way, it can more quickly provide the incentives to participants and thereby promote more participation. Alternatively, the sending element 408 may also send the fixed part to the participant in a late time or after completing the round.

Furthermore, the sending element 408 may send a floating part incentive to a successful participant after completing a round. This is because the floating part for the successful participant may be related to the contribution of the successful participant. In some cases, the contribution of the successful participant may relate to the contributions of the other successful participants. Thus, the floating part incentive for a successful participant may be determined when a round is completed.

Additionally, the sending element 408 may send the fixed part and possibly the floating part incentives to a successful participant after completing a round. In this way, it can save connection costs and system resources on the budget allocation apparatus.

As shown in FIG. 4, the budget allocation apparatus 400 may further comprise a stopping element 410. The stopping element 410 is configured to stop the data collection task when it is determined that the collected data satisfy a predefined criterion. For example, the stopping element 410 may stop the data collection when the collected data have satisfied an expected amount or certain requirements given by the data collection task initiator, such as required areas. Alternatively, the stopping element may stop the data collection when receiving an instruction from the operator, or any other suitable criterion. When it is determined that the collected data satisfy a predefined criterion, the stopping element 410 can stop the data collection task. Otherwise, the data collection task can continue. In this way, it can provide a more flexible way to control the data collection task and save budget in some cases where it is not necessary to perform all of the rounds.

The budget allocation apparatus 400 may further comprise an outputting element (not shown) configured to output the collected data and a budget balance. For example, the outputting element can output the collected data and a budget balance to the data collection task initiator. The budget balance can contain information about budget allocation, such as the spent budget and the rest of the budget, etc. It is noted that the outputting element can output the collected data and the budget balance at any suitable time, for example after a round, after several rounds, during a round, or after the task.

Moreover, the budget allocation apparatus 400 may further comprise a receiving element (not shown) configured to receive a message regarding a data collection task. The message may contain description about the budget and task, as discussed above.

The budget allocation apparatus 400 may further comprise a storage device (not shown) configured to store the collected data, the budget, and any other information necessary for its functions. The storage device can be any kind of computer readable storage, such as a hard disk, CDROM, DVD, SSD, a phase change memory (PCM), a random access memory (RAM), a read-only memory (ROM), an erasable programmable read-only memory (EPROM) or Flash memory.

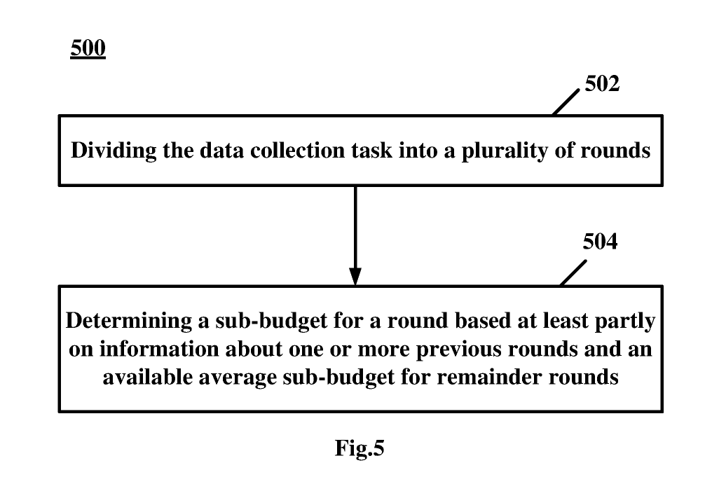

Under the same inventive concept, FIGS. 5 to 7 are flow charts showing processes for allocating budget in a data collection task according to some embodiments of the present disclosure. The present disclosure will be described below with reference to these figures. For same parts or functions as described in the previous embodiments, the description thereof is omitted for brevity.

FIG. 5 shows a process for allocating budget in a data collection task according to an embodiment of the present disclosure. The process 500 can be performed by the budget allocation apparatus 200 shown in FIG. 2. As shown in FIG. 5, the process 500 starts at step 502, where the data collection task is divided into a plurality of rounds. As discussed above, the data collection task may be a participatory sensing task, for which a budget B is given by the task initiator. The budget can be money, game point, cash coupon, score or the like. The data collection task can be divided into R rounds based on empirical or statistics information.

Then, at step 504, a sub-budget is determined for a round based at least partly on information about one or more previous rounds and an available average sub-budget for remainder rounds. As described above, the sub-budget of a round i which is denoted as B, may be smaller than or equal to an available average sub-budget for remainder rounds. For example, if a remainder budget is denoted as B′, and a remainder round number is denoted as R′, then

$${B}_{i} \leq \frac{{B}^{′}}{{R}^{′}} .$$

The information about one or more previous rounds comprises sub-budget for the nearest previous round, data collection performance in the one or more previous rounds, and/or current market state. As an example, the data collection performance in a round can be determined based at least partly on time used in the round, actual amount of data collected in the round and expected amount of data to be collected in the round. The data collection performance in a round can be determined according to formula 1, as described above.

Furthermore, the budget allocation may comprise a price deciding state and a price stabilizing state based on a price adjustment parameter. In the price deciding state β_{dy}, the sub-budget may vary from one round to another significantly in order to find the proper price rapidly. In the price stabilizing state β_{sd}, the budget allocation apparatus 200 may adjust the sub-budget for the round slightly and avoids volatile markets caused by accident. The budget allocation may be in the price deciding state by default, when it is initialized. Alternatively, the budget allocation apparatus 200 may maintain two state buckets, one for the price deciding state, β_{dy}, with a default value 1.0 and the other for the price stabilizing state, β_{sd}, with a default value 0.

Moreover, the price adjustment parameter can be determined based at least partly on the data collection performance in the one or more previous rounds and the current market state. For example, as described above, if the budget allocation apparatus 200 gets the data collection performance in previous rounds, it can compute the price adjust parameter for a next round based at least partly on the data collection performance in the one or more previous rounds and the current market state, such as according to formula 2.

As described above, the budget allocation apparatus 200 may determine the value of the price deciding state and the value of the price stabilizing state based at least partly on an absolute difference between the price adjust parameters of two adjacent rounds compared to a price adjust threshold, such as according to formulas 3 and 4. The current market state can be determined by β=max{β_{dy}, β_{sd}}, wherein β_{sd} denotes the parameter of the price stabilizing state, and β_{dy} denotes the parameter of the price deciding state.

Furthermore, the budget allocation apparatus 200 can determine a sub-budget for a round based at least partly on information about one or more previous rounds and an available average sub-budget for remainder rounds. Specifically, according to the price adjust parameters Dᵢ₊₁ for next round i+1, Dᵢ₊₁>1 may indicate increasing the sub-budget of the next round i+1. Dᵢ₊₁<1 may indicate decreasing the sub-budget of the next round i+1. Dᵢ₊₁=1 may indicate stabilizing the sub-budget of the next round i+1. Moreover, in order to avoid deficit, the budget allocation apparatus 200 may compare the resulting next round's sub-budget with the available average sub-budget

$$\frac{{B}^{′}}{{R}^{′}}$$

to guarantee the sub-budget of the next round i+1 is not over allocated than the available average sub-budget

$$\frac{{B}^{′}}{{R}^{′}} ,$$

given that the reminder available budget is B′ and the reminder round number is R′. As described above, the next round's sub-budget Bᵢ₊₁ can be determined according to formula 5.

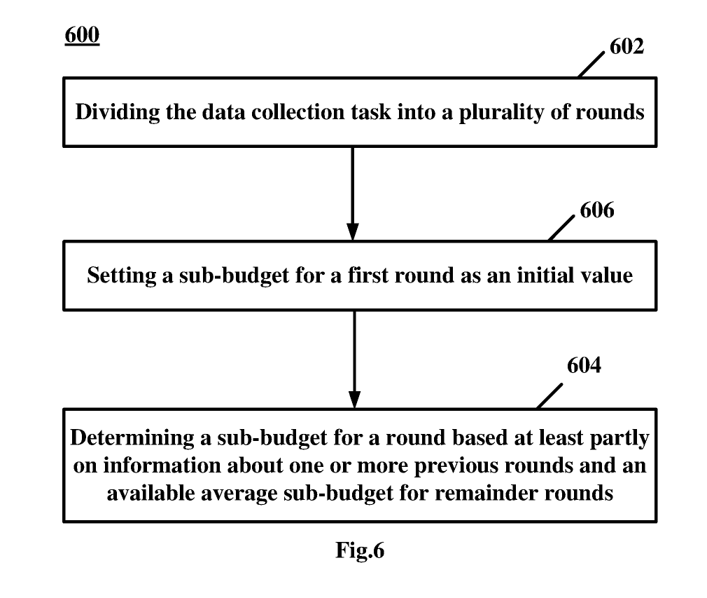

FIG. 6 shows a process for allocating budget in a data collection task according to another embodiment of the present disclosure. The process 600 can be performed by the budget allocation apparatus 300 shown in FIG. 3. As shown in FIG. 6, the process 600 comprises steps 602 and 604 which are similar to the steps 502 and 504 shown in FIG. 5. For brevity, the description of steps 602 and 604 is omitted herein.

After the data collection task has been divided into a plurality of rounds at step 602, the process 600 proceeds to step 606 where an initial sub-budget is set for the first round. As described above, this initial sub-budget may be smaller than or equal to an available average sub-budget for remainder rounds. For example, The sub-budget for the first round B₁ can be set to be at a low level, such as

$$\frac{B}{8 R} , \frac{B}{4 R} , \frac{B}{2 R} ,$$

or other suitable values, wherein

$$\frac{B}{R}$$

denotes the available average sub-budget for remainder rounds.

As described above, the sub-budget can be divided into two parts: a fixed part which is substantially the same amount for every successful participant; and a floating part which is determined according to a successful participant's contribution. The sum of the total fixed part and the total floating part could be smaller than or equal to the sub-budget for the round. Additionally, the budget allocation apparatus 200, 300 can determine the fixed part based at least partly on the sub-budget of the round, such as according to formula 6. After a round is completed, the floating part for a successful participant may be determined according to the participant's contribution, such as according to formula 7.

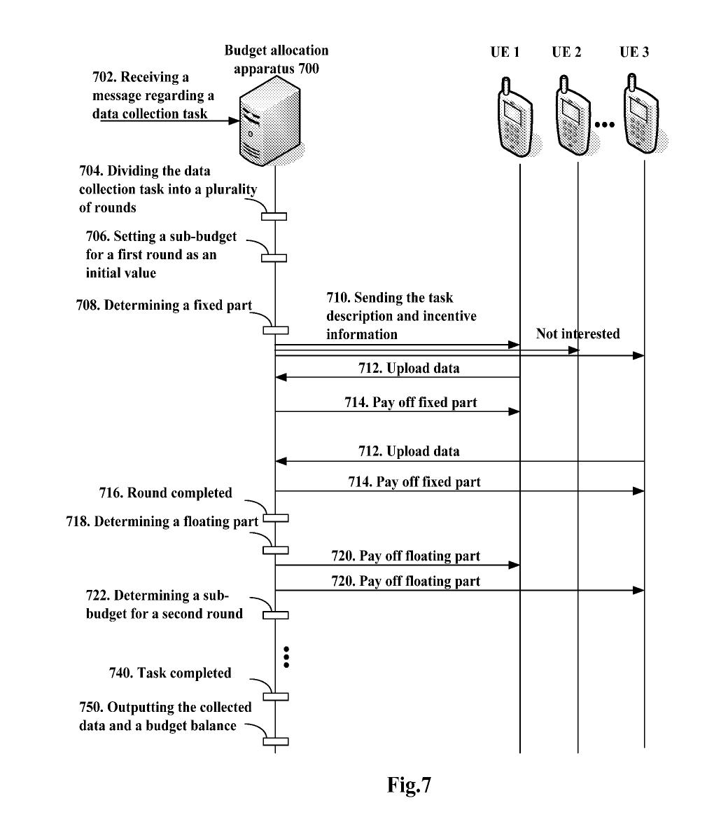

FIG. 7 shows a process 700 for allocating budget in a data collection task according to an embodiment of the present disclosure. The process 700 can be performed by the budget allocation apparatus 400 shown in FIG. 4.

As shown in FIG. 7, the system comprises a budget allocation apparatus 700 and a plurality of UEs, such as UE 1, UE 2 and UE 3. The process 700 starts from step 702, where the budget allocation apparatus 700 may receive a message regarding the data collection task. As described above, the message may include information about the task description and a budget for the task.

Then, at step 704, the budget allocation apparatus 700 may divide the data collection task into a plurality of rounds. At step 706, the budget allocation apparatus 700 may set an initial sub-budget for the first round, as described above. At step 708, the budget allocation apparatus 700 may determine a fixed part incentive, which is substantially the same amount for every successful participant.

At step 710, the budget allocation apparatus 700 may send description about the data collection task and incentive information to potential participants such as UE 1, UE 2 and UE 3. The incentive information may contain information about the fixed part and floating part incentives. As described above, the budget allocation apparatus 700 can use broadcast, multicast, unicast or other suitable transmission technologies to send the information.

After receiving the information, the users of UE 1, UE 3 may be interested in this task and participate in this task. They may upload sensing data to the budget allocation apparatus 700 or a data collection server (not shown) at step 712. The user of UE 2 may be busy and cannot join this task at this time. Moreover, other users can retrieve information about the data collection and adjust their participating strategy to get a higher bonus.

After receiving the uploaded data from the UE 1 and UE 3, the budget allocation apparatus 700 may immediately send the fixed part incentives to UE 1 and UE 3 if the uploaded data are qualified. Alternatively, the budget allocation apparatus 700 may send the fixed part incentives to the successful participants in a late time or after completing the round.

The first round is finished at 716, for example, when the time for the first round has expired or an expected amount of data have been obtained. Then, the budget allocation apparatus 700 may determine a floating part incentive for a successful participant according to the participant's contribution at step 718, for example, according to formula 7 as described above.

At step 720, the budget allocation apparatus 700 may send the floating part incentives to the successful participants, such as the users of UE 1 and UE 3 respectively. Alternatively, the budget allocation apparatus 700 may send the fixed part and the floating part incentives to the successful participants after completing the round. In this way, it can save connection costs and system resources.

Further, the process 700 may proceed to stop the data collection task when it is determined that the collected data satisfy a predefined criterion, as described above. Otherwise, if the task is not finished, the process 700 may proceed to step 722, where the budget allocation apparatus 700 may determine a sub-budget for the next round (round 2) based at least partly on information about one or more previous rounds and an available average sub-budget for remainder rounds as described in the above embodiments. Then the budget allocation apparatus 700 will perform similar steps as steps 708, 710, 714, 718, 720 described in the first round. The process will iterate until the task is finished.

Additionally, when the task completes, the process 700 can further proceed to step 750, where the budget allocation apparatus 700 may output the collected data and a budget balance. Moreover, the process 700 may further proceed to store the collected data and any other related information in a storage device, as described above.

According to an aspect of the disclosure it is provided an apparatus for budget allocation in a data collection task. Said apparatus comprises means configured to divide the data collection task into a plurality of rounds; and means configured to determine a sub-budget for a round based at least partly on information about one or more previous rounds and an available average sub-budget for remainder rounds.

According to an embodiment, the apparatus comprises means configured to set a sub-budget for a first round as an initial value.

According to an embodiment, wherein the sub-budget comprises: a fixed part which is substantially the same amount for every successful participant; and a floating part which is determined according to a successful participant's contribution.

According to an embodiment, wherein the information about one or more previous rounds comprises sub-budget for the nearest previous round, data collection performance in the one or more previous rounds, and/or current market state.

According to an embodiment, wherein the data collection performance in a round is determined based at least partly on time used in the round, actual amount of data collected in the round and expected amount of data to be collected in the round.

According to an embodiment, wherein the budget allocation has a price deciding state and a price stabilizing state based on a price adjustment parameter.

According to an embodiment, wherein the price adjustment parameter is determined based at least partly on the data collection performance in the one or more previous rounds and the current market state.

In an embodiment, the apparatus comprises means configured to send description about the data collection task and incentive information to a potential participant, wherein the incentive information contains at least information about the fixed part and floating part of the budget.

In an embodiment, the apparatus comprises means configured to stop the data collection task when it is determined that the collected data satisfy a predefined criterion.

It is noted that any of the components of the apparatus 200, 300, 400 depicted in FIG. 2-4 can be implemented as hardware or software modules. In the case of software modules, they can be embodied on a tangible computer-readable recordable storage medium. All of the software modules (or any subset thereof) can be on the same medium, or each can be on a different medium, for example. The software modules can run, for example, on a hardware processor. The method steps can then be carried out using the distinct software modules, as described above, executing on a hardware processor.

Additionally, an aspect of the disclosure can make use of software running on a general purpose computer or workstation. Such an implementation might employ, for example, a processor, a memory, and an input/output interface formed, for example, by a display and a keyboard. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. The processor, memory, and input/output interface such as display and keyboard can be interconnected, for example, via bus as part of a data processing unit. Suitable interconnections, for example via bus, can also be provided to a network interface, such as a network card, which can be provided to interface with a computer network, and to a media interface, such as a diskette or CD-ROM drive, which can be provided to interface with media.

Accordingly, computer software including instructions or code for performing the methodologies of the disclosure, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

As noted, aspects of the disclosure may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the disclosure may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

The flowchart and block diagrams in the figures illustrate the architecture, functionality, and operation of possible implementations of systems, methods and computer program products according to various embodiments of the disclosure. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In any case, it should be understood that the components illustrated in this disclosure may be implemented in various forms of hardware, software, or combinations thereof, for example, application specific integrated circuit(s) (ASICS), functional circuitry, an appropriately programmed general purpose digital computer with associated memory, and the like. Given the teachings of the disclosure provided herein, one of ordinary skill in the related art will be able to contemplate other implementations of the components of the disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises”, “containing” and/or “comprising,” when used in this specification, specify the presence of stated features, integers, steps, operations, elements, and/or components, but do not preclude the presence or addition of another feature, integer, step, operation, element, component, and/or group thereof.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

1-21. (canceled)

22. A method for budget allocation in a data collection task, comprising:
dividing the data collection task into a plurality of rounds; and
determining a sub-budget for a round based at least partly on information about one or more previous rounds and an available average sub-budget for remainder rounds.

23. The method according to claim 22, further comprising:
setting a sub-budget for a first round as an initial value.

24. The method according to claim 22, wherein the sub-budget comprises:
a fixed part which is substantially the same amount for every successful participant; and
a floating part which is determined according to a successful participant's contribution.

25. The method according to claim 22, wherein the information about one or more previous rounds comprises sub-budget for the nearest previous round, data collection performance in the one or more previous rounds, and/or current market state.

26. The method according to claim 25, wherein the data collection performance in a round is determined based at least partly on time used in the round, actual amount of data collected in the round and expected amount of data to be collected in the round.

27. The method according to claim 25, wherein the budget allocation has a price deciding state and a price stabilizing state based on a price adjustment parameter.

28. The method according to claim 27, wherein the price adjustment parameter is determined based at least partly on the data collection performance in the one or more previous rounds and the current market state.

29. The method according to claim 22, further comprising:
sending description about the data collection task and incentive information to a potential participant, wherein the incentive information contains at least information about the fixed part and floating part of the budget.

30. The method according to claim 22, further comprising:
stopping the data collection task when it is determined that the collected data satisfy a predefined criterion.

31. An apparatus for budget allocation in a data collection task comprising:
at least one processor; and
at least one memory including computer program code,
the at least one memory and the computer program code configured to, with the at least one processor, cause the apparatus to perform at least the following:
divide the data collection task into a plurality of rounds; and
determine a sub-budget for a round based at least partly on information about one or more previous rounds and an available average sub-budget for remainder rounds.

32. The apparatus according to claim 31, wherein the at least one memory and the computer program code configured to, with the at least one processor, cause the apparatus to further perform at least the following:
set a sub-budget for a first round as an initial value.

33. The apparatus according to claim 31, wherein the sub-budget comprises:
a fixed part which is substantially the same amount for every successful participant; and
a floating part which is determined according to a successful participant's contribution.

34. The apparatus according to claim 31, wherein the information about one or more previous rounds comprises sub-budget for the nearest previous round, data collection performance in the one or more previous rounds, and/or current market state.

35. The apparatus according to claim 34, wherein the data collection performance in a round is determined based at least partly on time used in the round, actual amount of data collected in the round and expected amount of data to be collected in the round.

36. The apparatus according to claim 34, wherein the budget allocation has a price deciding state and a price stabilizing state based on a price adjustment parameter.

37. The apparatus according to claim 36, wherein the price adjustment parameter is determined based at least partly on the data collection performance in the one or more previous rounds and the current market state.

38. The apparatus according to claim 31, wherein the at least one memory and the computer program code configured to, with the at least one processor, cause the apparatus to further perform at least the following:
send description about the data collection task and incentive information to a potential participant, wherein the incentive information contains at least information about the fixed part and floating part of the budget.

39. The apparatus according to claim 31, wherein the at least one memory and the computer program code configured to, with the at least one processor, cause the apparatus to further perform at least the following:
stop the data collection task when it is determined that the collected data satisfy a predefined criterion.

40. A non-transitory computer readable medium having encoded thereon statements and instructions to cause a processor to:
divide a data collection task into a plurality of rounds; and
determine a sub-budget of a budget for the data collection task for a round based at least partly on information about one or more previous rounds and an available average sub-budget for remainder rounds.

41. The non-transitory computer readable medium according to claim 40, having encoded thereon statement and instructions to cause the processor further to:
set a sub-budget for a first round as an initial value.
